(19) United States
(12) Patent Application Publication
(10) Pub. No.: US 2006/0226780 A1
(43) Pub. Date: Oct. 12, 2006

(54) Plasma display panel

(76) Inventors: Jae-Ik Kwon, Asan-si (KR); Kyoung-Doo Kang, Seoul (KR); Won-Ju Yi, Asan-si (KR); Jeong-Chull Ahn, Cheonan-si (KR); Eun-Young Jung, Yongin-si (KR)

Correspondence Address: Robert E. Bushnell, Suite 300, 1522 K. Street, N.W., Washington, DC, 20005, US

(21) Appl. No.: 11/451,479

(22) Filed: Jun. 13, 2006

Related U.S. Application Data
(63) Continuation-in-part of application No. 11/033,518, filed on Jan. 12, 2005.

(30) Foreign Application Priority Data
Mar. 24, 2004 (KR) 2004-19982
Mar. 29, 2004 (KR) 2004-21151

(51) Int. Cl. H01J 17/49

(52) U.S. Cl. 313/586; 313/582; 313/292; 313/238

(57) ABSTRACT

The plasma display panel (PDP) includes: a front panel; a rear panel disposed in parallel with the front panel; a plurality of opaque side dielectric ribs disposed between the front panel and the rear panel to define a plurality of discharge cells, and formed of a dielectric material; a lower discharge electrode and an upper discharge electrode disposed within the plurality of opaque side dielectric ribs; a plurality of phosphor layers corresponding to the discharge cells; and a discharge gas disposed inside the discharge cells. The structure of the PDP limits an outer reflection of an external light source and increase the reflection of visible rays emitted from the phosphor, increasing the aperture ratio of the front panel, and reducing the occurrence of a permanent residual image.

### CROSS-REFERENCE TO RELATED APPLICATIONS

This application is a continuation-in-part application of U.S. application Ser. No. 11/033,518 filed in the U.S. Patent & Trademark Office on 12 Jan. 2005, and assigned to the assignee of the present invention.

### CLAIM OF PRIORITY

This application makes reference to, incorporates the same herein, and claims all benefits accruing under 35 U.S.C. § 119 from applications for PLASMA DISPLAY PANEL earlier filed in the Korean Intellectual Property Office on the 24 Mar. 2004 and there duly assigned Serial No. 2004-19982, and for PLASMA DISPLAY PANEL earlier filed in the Korean Intellectual Property Office on the 29 Mar. 2004 and there duly assigned Serial No. 2004-21151, and under 35 U.S.C. §120 from an application for PLASMA DISPLAY PANEL earlier filed in the U.S. Patent & Trademark Office on 12 Jan. 2005 and there duly assigned Ser. No. 11/033,518.

### BACKGROUND OF THE INVENTION

1. Field of the Invention

The present invention relates to a Plasma Display Panel (PDP), and more particularly, to a PDP that forms an image by applying a discharge voltage to a plurality of electrodes arranged on two panels facing each other to generate ultraviolet rays which excite phosphor layers.

2. Description of the Related Art

Recently, a flat panel display employing a plasma display panel (PDP) has been in the spotlight as a next generation display owing to superior characteristics such as a large-sized screen, a high picture quality, a slim profile and a wide viewing angle, a simple fabrication method, and it being easy to make a large-sized screen compared with other flat displays.

The PDP may be classified into a DC (direct current) type PDP, an AC (alternating current) type PDP, and a hybrid type PDP according to a discharge voltage applied to the panel, and also be classified into a facing discharge type PDP and a surface discharge type PDP according to a discharge structure.

The DC type PDP has a structure in which all electrodes are exposed to a discharge space and charges move directly between the electrodes. The AC type PDP has a structure in which at least one electrode is covered with a dielectric layer, and charges do not move directly between the corresponding electrodes but discharge is performed by wall charges.

The DC type PDP has a drawback in that the electrodes are seriously damaged because charges are directly moved between corresponding electrodes. To this end, the AC type PDP, especially, an AC type PDP having a three-electrode surface discharge structure has been generally employed.

Referring to FIG. 1, a conventional surface discharge type PDP 10 with such an AC type three-electrode surface discharge structure includes a front panel 20 and a rear panel 30.

Address electrodes 33 generating an address discharge, a rear dielectric layer 35 covering the address electrodes 33, barrier ribs 37 partitioning discharge cells, and a phosphor layer 39 formed on both sidewalls of each of the barrier ribs 37 and on the rear dielectric layer 35 on which the barrier ribs 37 are not formed are arranged on the rear panel 30.

The front panel 20 is spaced apart from and facing the rear panel 30. Moreover, common electrodes 22, scan electrodes 23, a front dielectric layer 25 covering the common electrodes 22 and the scan electrodes 23, and a passivation layer 29 covering the front dielectric layer 25 are arranged on the front panel.

The common electrodes 22 disposed on the front panel 20 through which visible rays generated from the phosphor layer 39 of a discharge space pass, have a transparent common electrode 22a and a bus common electrode 22b disposed at one edge of the transparent common electrode 22a, the scan electrodes 23 have a transparent scan electrode 23a and a bus scan electrode 23b disposed at one edge of the transparent scan electrode 23a, and the front dielectric layer 25 and the passivation layer 29 covering the front dielectric layer 25 are sequentially formed on the common electrodes 22 and the scan electrodes 23. Due to the aforementioned elements, only 60% of the visible rays can pass through the front panel 20, which serves as an important factor.

Also, the conventional surface discharge PDP 10 has a drawback that the luminous efficiency is low because electrodes generating a discharge are arranged on an upper surface of the discharge space, i.e., on an inner surface of the front panel 20 through which the visible rays pass so that the discharge is generated in the inner surface of the front panel 20.

Further, the conventional surface discharge PDP 10 may cause a permanent residual image because when the conventional surface discharge PDP 10 is used for a long time, charged particles of discharge gases generate ion sputtering in the phosphor due to an applied electric field.

Furthermore, the front dielectric layer formed on the front panel 20 should be transparent, such that the visible rays excited from the phosphor layer pass therethrough. Due to the transparent front dielectric layer, external light that is incident into the PDP is reflected by the transparent front dielectric layer and then emitted to an exterior. As a result, the conventional surface discharge PDP 10 has a drawback that a contrast ratio is not high.

To improve the above drawbacks, a black stripe is disposed on non-discharge regions, or a line width of the bus electrode is increased, thereby more or less increasing the contrast ratio. However, since the size of the non-discharge area is limited so as to maintain the aperture ratio above a predetermined value, there is a limitation in disposing the black stripe or increasing the line width of the bus electrode.

### SUMMARY OF THE INVENTION

It is therefore, an object of the present invention to provide a plasma display panel (PDP) that can remarkably increase the aperture ratio and transmittance, compared with the conventional PDP and also remarkably extend a discharge area.

It is also another object of the present invention to provide a PDP that can efficiently use space charges of plasma by concentrating discharge plasma on a predetermined region of discharge space, for example, on a middle portion, operate at a low voltage, and remarkably reduce the permanent residual image phenomenon by substantially improving the luminous efficiency.

It is a further object of the present invention to provide a PDP with a structure that can reduce an outer reflection of an external light source and increase the reflection of visible rays emitted from the phosphor.

It is yet another object to provide a PDP through side dielectric ribs preventing external light from being reflected, bright room contrast is increased and visible rays excited from the phosphor layer are reflected so that brightness and color purity are enhanced, resulting in an increase in light efficiency.

It is a further object to provide a PDP through the structure of the PDP being much improved and the amount of plasma being greatly increased, much visible rays are emitted, brightness is increased, and a low voltage operation is possible, thereby increasing the luminous efficiency.

According to an aspect of the present invention, there is provided a PDP including: a front panel, a rear panel, a plurality of opaque side dielectric ribs, a lower discharge electrode and an upper discharge electrode, a phosphor layer, and a discharge gas.

The rear panel is disposed in parallel with the front panel. The plurality of opaque side dielectric ribs are disposed between the front panel and the rear panel to define a plurality of discharge cells, and formed of a dielectric material. The lower discharge electrode and upper discharge electrode are disposed within the plurality of opaque side dielectric ribs. A plurality of phosphor layers corresponds to the discharge cells. The discharge gas is disposed inside the discharge cells.

The plurality of opaque side dielectric ribs may take on a dark color.

The above plasma display panel may further include at least one floating electrode disposed within the plurality of opaque side dielectric ribs so as to enclose the discharge cells, or extending in one direction within the front panel.

According to another aspect of the present invention, there is provided a plasma display panel including: a front panel, a rear panel, a plurality of side dielectric ribs, an upper discharge electrode, a lower discharge electrode, a phosphor layer, and a discharge gas.

The rear panel is disposed in parallel with the front panel. The plurality of side dielectric ribs include a plurality of first dark-colored side dielectric ribs disposed between the front panel and the rear panel to define a plurality of discharge cells and formed of a dielectric material, and a plurality of second side dielectric ribs stacked on lower surfaces of the plurality of first side dielectric ribs, formed of a dielectric material, and having a higher light reflectivity than the first side dielectric ribs. The lower discharge electrode and upper discharge electrode are disposed within the plurality of side dielectric ribs. A plurality of phosphor layers corresponds to the discharge cells. The discharge gas is disposed inside the discharge cells.

The second side dielectric ribs may take on a bright color.

At this time, the first side dielectric ribs may take on a dark color.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is an exploded perspective view of a conventional PDP;

FIG. 2 is an exploded perspective view of a PDP according to a first embodiment of the present invention;

FIG. 3 is a sectional view taken along the line III-III of FIG. 2;

FIG. 4 is a sectional view taken along the line IV-IV of FIG. 3;

FIG. 5 is a first modification of FIG. 3;

FIG. 6 is a second modification of FIG. 3;

FIG. 7A is a third modification of FIG. 3;

FIG. 7B is a fourth modification of FIG. 3;

FIG. 8 is an exploded perspective view of a modification of FIG. 2;

FIG. 9 is an exploded perspective view of a PDP according to a second embodiment of the present invention;

FIG. 10 is a sectional view taken along the line V-V of FIG. 9;

FIG. 11 is a first modification of the PDP shown in FIG. 10; and

FIG. 12 is a second modification of the PDP shown in FIG. 10.

### DETAILED DESCRIPTION OF THE INVENTION

The present invention will now be described more fully with reference to the accompanying drawings, in which exemplary embodiments of the invention are shown.

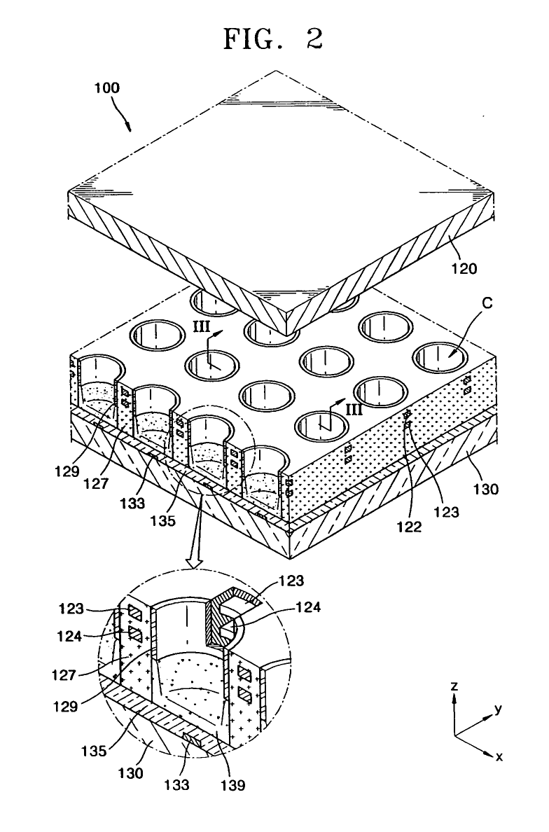

A Plasma Display Panel (PDP) according to a first embodiment of the present invention will now be described in detail with reference to FIGS. 2 through 4.

A PDP 100 according to a first embodiment of the present invention includes an upper panel (front panel) 120, a lower panel (rear panel) 130, side dielectric ribs 127, upper discharge electrodes 122, lower discharge electrodes 123, phosphor layers 139, and a discharge gas (not shown).

The front panel 120 which a visible rays of light can pass there through so as to project an image is arranged in parallel with the rear panel 130. The side dielectric ribs 127 are formed between the front panel 120 and the rear panel 130. The side dielectric ribs 127 are arranged at a non-discharge region to partition discharge cells. As shown in FIG. 2, each of the side dielectric ribs 127 is interposed between neighboring discharge cells C and thus acts as a barrier rib. The barrier rib may be formed inside the side dielectric rib 127 interposed between the discharge cells C. In this case, the barrier ribs define the discharge cells C, thereby preventing cross talk.

The upper discharge electrodes 122 and the lower discharge electrodes 123 are formed within the side dielectric ribs 127. The upper discharge electrode 122 means an electrode arranged at an upper portion of the lower discharge electrode 123. In this case, at least one of the upper discharge electrodes 122 and the lower discharge electrodes 123, which correspond to each of the discharge cells C, may partly enclose the discharge cell C. Alternatively, the upper discharge electrodes 122 and the lower discharge electrodes 123, which correspond to each of the discharge cells C, may completely enclose the discharge cell C.

Also, as shown in FIG. 2, cross-sections of the side dielectric ribs 127 are circular. Accordingly, the upper discharge electrodes 122 and the lower discharge electrodes 123 may be formed circular. In this case, since the side dielectric ribs 127 do not have edges, electric discharges are not concentrated in the side dielectric ribs 127 during sustain discharge. Consequently, the life of a panel can become longer, and the creation of a permanent residual image can be prevented. However, the present invention is not limited thereto. The side dielectric ribs 127, the upper discharge electrodes 122, and the lower discharge electrodes 123 may be square, octagonal, etc. The side dielectric ribs 127, the upper discharge electrodes 122, and the lower discharge electrodes 123 may also have a curved shape or a closed curve such as an ellipse that does not have any edges, including for example an oval or rounded rectangle.

The upper discharge electrodes 122 and the lower discharge electrodes 123 may be formed crossing with one another. In this case, one of the upper discharge electrodes 122 and the lower discharge electrodes 123 acts as an address electrode and the other acts as a discharge electrode to generate a discharge. Alternatively, one of the upper discharge electrodes 122 and the lower discharge electrodes 123 may act as an address electrode, and the other one of the upper discharge electrodes 122 and the lower discharge electrodes 123 may be divided into two electrodes acting as X and Y electrodes, respectively.

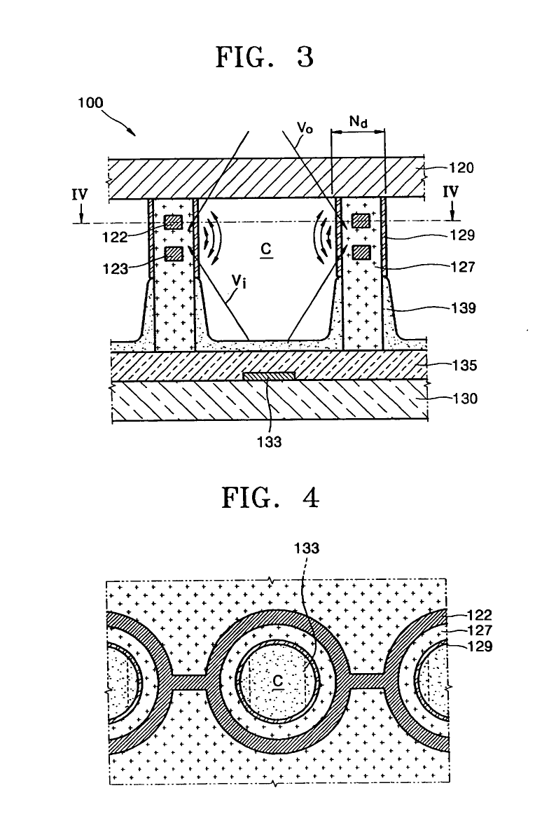

Also, as shown in FIGS. 2 and 3, the upper discharge electrodes 122 and the lower discharge electrodes 123 may be arranged extending in one direction in parallel with one another and the PDP may further include address electrodes 133 extending to cross the upper discharge electrodes 122 and the lower discharge electrodes 123. In this case, it is preferable that sides of the address electrodes 133 are covered by protective layer 129, the address electrodes 133 are arranged between the rear panel 130 and the phosphor layers 139, and a dielectric layer 135 is formed between the address electrodes 133 and the phosphor layers 139.

In more detail, the PDP includes: the rear panel 130; the address electrodes 133 disposed on the rear panel 130 and extending in one direction; the dielectric layer 135 covering the address electrodes; the lower discharge electrodes 123 enclosing the upper portions of the discharge cells C and extending to cross with the address electrodes; the upper discharge electrodes 122 enclosing the upper portions of the discharge cells C and extending in parallel with the scanning electrodes; the side dielectric ribs 127 covering the upper discharge electrodes 122 and the lower discharge electrodes 123; the phosphor layers 139 formed on sides of the side dielectric ribs and on the dielectric layer on which the barrier ribs are not formed; the discharge gas filled within the discharge cells; and the front panel 120 disposed on the side dielectric ribs 127 in parallel with the rear panel 130.

The rear panel 130 supports the address electrodes 133 and the dielectric layer 135 and it is usually formed of a material whose main component is a glass.

The address electrodes 133 generate an address discharge so as to make it easy to generate a sustain discharge between the lower discharge electrode 123 and the upper discharge electrode 122. Specifically, the address electrodes 133 function to lower a voltage at which the sustain discharge is initiated.

When the address electrodes 133 are formed on the rear panel 130, the upper discharge electrode 122 and the lower discharge electrode 123 may be the scan electrode and the common electrode, respectively. However, it is more preferable that the upper discharge electrode 122 and the lower discharge electrode 133 are the common electrode and the scanning electrode, respectively. This is because a discharge pass between the scanning electrode and the address electrode 133 is shortened so that the address discharge is smoothly generated. Therefore, for convenience's sake, it is assumed that the upper discharge electrode 122 and the lower discharge electrode 123 act as the common electrode and the scanning electrode, respectively.

In this embodiment, the lower discharge electrode 123 and the upper discharge electrode 122 can be arranged to partly or completely enclose the upper portion of the discharge cell C. The present invention is not limited thereto. The lower discharge electrode 123 and the upper discharge electrode 122 can be arranged to enclose the lower portion of the discharge cell C. In this case, the phosphor layers 139 are formed on the front panel 120.

The lower discharge electrode 123 and the upper discharge electrode 122 may be arranged crossing with each other. However, when the address electrode 133 is formed on the rear panel, it is preferable that the lower discharge electrode 123 and the upper discharge electrode 122 are arranged in parallel.

Also, although each of the lower discharge electrodes 123 and the upper discharge electrodes 122 is arranged with one electrode in FIG. 2, it may be formed with two or more sub electrodes.

The address discharge is generated between the lower discharge electrode 123 and the address electrode 133. If the address discharge is ended, positive ions are accumulated in the lower discharge electrode 123 and electrons are accumulated in the upper discharge electrode 122. Thus, the sustain discharge is more easily generated between the upper discharge electrode 122 and the lower discharge electrode 123.

The dielectric layer 135 is formed of a dielectric material that can prevent the address electrode from being damaged when the positive ions or electrons are collided with the address electrode 133 during the discharge and can also induce charges. PbO, B₂O₃ or SiO₂ is used as the dielectric material.

If the PDP 100 of the present invention includes the address electrodes 133, the lower discharge electrodes 123 and the upper discharge electrodes 122 are electrodes for the sustain discharge. The sustain discharge for implementing the images on the PDP is generated between the lower discharge electrodes 123 and the upper discharge electrodes 122. The lower discharge electrodes 123 and the upper discharge electrodes 122 are formed of conductive materials, such as aluminium and copper.

At this point, the address electrodes 133 extend crossing with the upper discharge electrodes 122 and the lower discharge electrodes 123. In this case, it is preferable that the upper discharge electrodes 122 extend in parallel with the lower discharge electrodes 123. That the lower discharge electrodes 123 extend crossing with the address electrodes 133 means that columns of the discharge cells C passing the address electrodes are crossed with columns of the discharge cells C passing the lower discharge electrodes 123. Also, that the upper discharge electrodes 122 extend in parallel with the lower discharge electrodes 123 means that the upper discharge electrodes are disposed spaced apart from the lower discharge electrodes by a predetermined distance.

The side dielectric ribs 127 partition the adjacent discharge cells C and are formed of the dielectric material so that the lower discharge electrodes 123 and the upper discharge electrodes 122 are prevented from being directly conductive during the sustain discharge. Also, the side dielectric ribs 127 prevent the electrodes 122 and 123 from being damaged when the charged particles are directly collided with the electrodes, and they guide the charged particles to accumulate the wall charges.

The side dielectric ribs 127 are arranged at non-discharge region Nd, which corresponds to a region between the adjacent discharge cells C as seen for example in FIG. 3. Thus, the visible rays Vi excited at the phosphor layer are not required to pass through the side dielectric ribs 127 so as to implement the image. That is, the side dielectric ribs 127 need not be transparent.

Further, if the side dielectric ribs 127 are transparent, the visible rays Vi pass through the side dielectric ribs 127 which partition the adjacent discharge cells C, such that the visible rays Vi leak toward the adjacent discharge cells. Consequently, picture quality and color reproduction are degraded and a contrast ratio decreases because external rays Vo incident to the panel are reflected from the side dielectric ribs 127.

Accordingly, in this embodiment, the side dielectric ribs 127 are formed opaquely.

In this case, it is preferable that the side dielectric ribs 127 take on a dark color. The reason for this is because the dark color absorbs the light well. That is, if the side dielectric ribs 127 take on the dark color, the incident external rays Vo having passed through the front panel 120 are absorbed by the side dielectric ribs 127, so that the incident external rays Vo are not reflected. Thus, the nominal contrast ratio increases remarkably. Here, the dark color means a color having brightness of less than four in a Munsell color system.

The side dielectric ribs 127 may include a dark-colored pigment in dielectric materials whose main component is PbO, B₂O₃ or SiO₂. That is, the side dielectric ribs 127 can take on the opaque dark color by adding the dark-colored pigment to the components of the front dielectric layer adopted in the conventional PDP.

In this case, the pigment component may be one selected from the group including CdSe, CdS, CoO, Al₂O₃, ZnO, Fe₂O₃, Cr₂O₃, Cr₂O₃, MnO₂, CuO, and NiO.

It is preferable that the side dielectric ribs 127 are covered with the protective layer 129. Although a layer that is generally formed of MgO is not a required component, it can prevent the side dielectric ribs from being damaged when the charged particles are collided with the side dielectric ribs 127 and can emit a lot of secondary electrons during the discharge. Therefore, it is preferable that the PDP includes the protective layer. The protective layer 129 may be arranged only at the sides of the side dielectric ribs 127. However, for the sake of convenience in manufacture, the protective layer 129 can be simultaneously deposited on the sides of the side dielectric ribs 127 and a lower surface of the front panel 120 in which the side dielectric ribs 127 are not formed.

The phosphor layer 139 includes a component which receives ultraviolet rays emitted by the sustain discharge and irradiates visible rays. The phosphor layer formed at the red discharge subpixel includes a phosphor such as Y(V, P)0₄:Eu, and the phosphor layer formed at the green discharge subpixel includes a phosphor such as Zn₂SiO₄:Mn and YBO₃:Tb. Also, the phosphor layer arranged at the blue discharge subpixel includes a phosphor such as BAM:Eu.

The discharge gas filled within the discharge cells is, for example, an Ne—Xe mixed gas containing Xe as a main discharge gas. If necessary, a predetermined amount of Ne may be replaced with He.

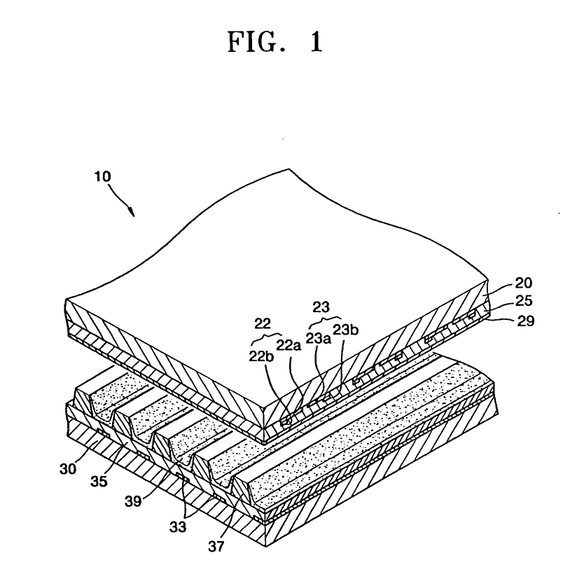

The front panel 120 is formed of a material, such as a glass, which has a good light transmittance. Unlike the front panel of the conventional PDP shown in FIG. 1, the front panel 120 of the present invention does not include the transparent scan electrode 23a and the transparent common electrode 22a formed of the ITO (Indium tin oxide) layer, the bus common electrodes 22b and 23b formed of the meal, the front dielectric layer 25 covering the electrodes 22a, 22b, 23a and 23b, and the passivation layer 29. Thus, the front transmittance of the visible rays is remarkably improved up to about 60-90% compared with the prior art. Therefore, when the images are reproduced at the brightness of the conventional level, the electrodes 122 and 123 are driven at a relatively low voltage, thereby improving the luminous efficiency.

In this case, since the upper discharge electrode 122 and the lower discharge electrode 123 are arranged not at the front panel 120 through which the visible rays pass, but at the sides of the discharge spaces, an electrode (e.g., a metal electrode) with small resistance instead of a transparent electrode with large resistance can be used as the discharge electrode. Consequently, it is possible to obtain a fast discharge response time and drive the PDP at a low voltage without any distortion of waveform.

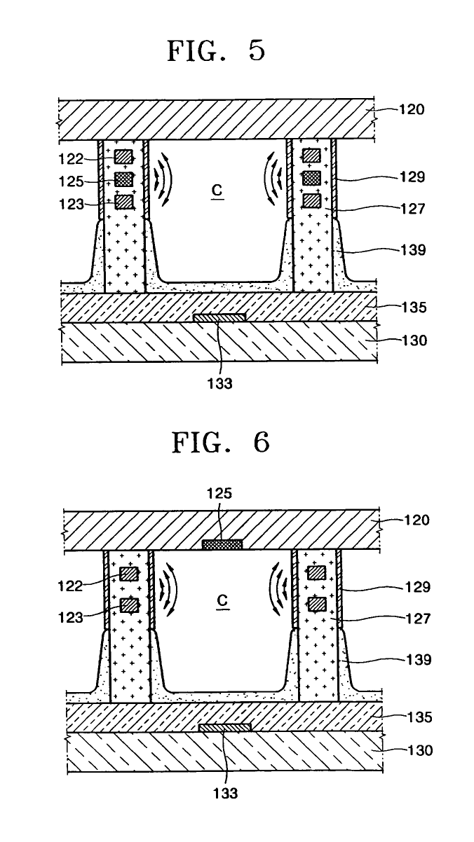

Referring to FIGS. 5 and 6, the PDP 100 according to the first embodiment of the present invention may further include a floating electrode 125. The floating electrode 125 is not coupled to a separate active voltage source and it is formed of a material having a high electrical conductivity.

In this case, as shown in FIG. 5, the floating electrode 125 may extend in parallel with the upper discharge electrode 122 and the lower discharge electrode 123 therebetween. However, the position of the floating electrode 125 is not limited to it. That is, the floating electrode 125 can be formed at any position enclosing the discharge cells C. Also, although FIG. 5 shows that one floating electrode 125 is formed, a plurality of floating electrodes 125 can be applied.

Referring to FIG. 6, the floating electrode 125 can also be arranged in one direction within the front panel 120. In this embodiment, the discharge is generated at the side dielectric ribs 127 at which the upper and lower discharge electrodes 122 and 123 are disposed. Thus, a discharge area is expanded so that a discharge efficiency is improved and a discharge voltage decreases. However, it is preferable that the floating electrode 125 disposed at the front panel 120 is formed of a transparent electrode, such as ITO, because the visible rays due to the discharge is transmitted through the front panel 120.

In this embodiment, the address discharge is generated by applying the address voltage to the address electrode 133 and the lower discharge electrode 123. Then, the discharge cells C to generate the sustain discharge are selected.

Thereafter, when an AC sustain discharge voltage is applied between the lower discharge electrode 123 and the upper discharge electrode 122, the sustain discharge occurs between the lower discharge electrode 123 and the upper discharge electrode 122. If the floating electrode 125 is arranged, the floating electrode 125 has a potential between a potential of the upper discharge electrode 122 and a potential of the lower discharge electrode 123, and the sustain discharge is generated together with the upper and lower discharge electrodes 122 and 123.

Ultraviolet rays are emitted while an energy level of the discharge gas excited due to the sustain discharge is lowered. Then, the ultraviolet rays excite the phosphor layer 139 deposited within the discharge cells. While an energy level of the excited phosphor layer is lowered, visible rays are emitted, resulting in the implementation of the image.

In the case of the conventional PDP shown in FIG. 1, the sustain discharge between the scanning electrode 23 and the common electrode 22 is generated in a horizontal direction such that a discharge area is relatively narrow. However, in the case of the PDP according to the present invention, the sustain discharge is generated in a vertical direction at all sides defining the discharge cells C such that a discharge area is relatively wide.

Also, in this embodiment, the sustain discharge is first formed in a closed curve along the discharge cells C and then gradually diffused toward central portions of the discharge cells. Thus, a volume of an area where the sustain discharge is generated is increased. Further, space charges that are not used within the discharge cells in the prior art attribute to the luminescence. Consequently, the luminous efficiency of the PDP is improved.

In addition, in the discharge cells of the PDP according to the first embodiment of the present invention, the sustain discharge is generated only at the upper portions of the discharge cells, as shown in FIG. 3. Therefore, the ion sputtering of the phosphor due to the charged particles is prevented. Thus, even when the same images are displayed for a long time, a permanent residual image does not occur.

Further, even when the high concentration Xe gas is used as the discharge gas, the luminous efficiency can be improved. A low voltage driving is difficult when the high concentration Xe gas is used as the discharge gas so as to increase the luminous efficiency. However, as described above, the PDP and the flat display device having the same according to the present invention can achieve the low voltage driving. Therefore, even when the high concentration Xe gas is used as the discharge gas, the low voltage driving is possible so that the luminous efficiency is improved.

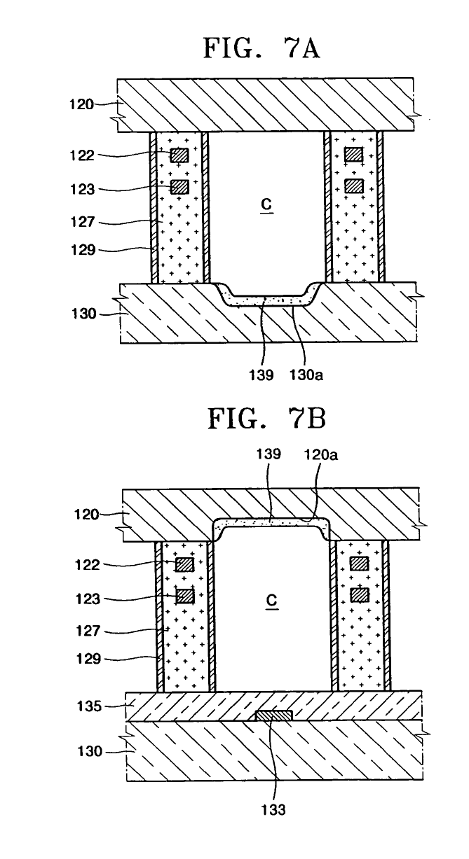

FIGS. 7A and 7B are sectional views of modifications of FIG. 3. As shown in FIG. 7A, a groove 130a is formed in the rear panel 130 for each of the discharge cells C, and the phosphor layers 139 are formed at least on the grooves 130a. In this case, electrodes, for example, address electrodes, may not be formed on the rear panel 130. In other words, without electrodes formed thereon, the rear panel 130 can take any shape. In this case, if the grooves 130a are formed in the rear panel 130, the surface area of the rear panel 130 increases by the surface area of the grooves 130a. Further, if the phosphor layers 139 are coated on the grooves 130a, the surface area of the phosphor layers 139 also increases.

Referring to FIG. 7B, a groove 120a is formed in the front panel 120 for each of the discharge cells C, and the phosphor layers 139 are formed at least on the grooves 120a. In this case, the PDP is a transmissive PDP. Since it is not necessary to form electrodes on the front panel 120, the grooves 120a can be formed in the front panel 120. When the phosphor layers 139 are coated on the grooves 120a, the surface area of the phosphor layers 139 increases.

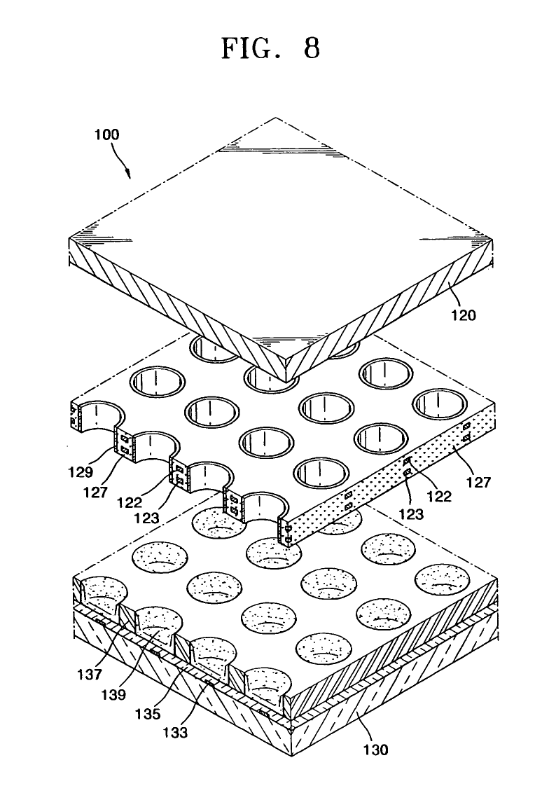

FIG. 8 is an exploded perspective view of a modification of FIG. 2. Referring to FIG. 8, the PDP 100 may further include partition walls 137. The partition walls 137 may be formed between the side dielectric ribs 127 and the rear panel 130. In this case, the partition walls 137 are disposed between the side dielectric ribs 127 and the rear panel 130, and define the discharge cells C in cooperation with the side dielectric ribs 127. The partition walls 137 prevent the occurrence of undesirable discharge among the discharge cells C. FIG. 8 shows that the partition walls 137 define the discharge cells C in a circular shape, but the invention is not limited thereto, and the discharge cells C may be defined in other shapes, such as a honeycomb shape. The partition walls 137 can also be a closed curve shape. Furthermore, FIG. 8 shows that the discharge cells C defined by the partition walls 137 have a circular cross-section, but the invention is not limited thereto, and the cross-section thereof may be formed in a polygonal shape, such as a triangle and a pentagon, or may be formed as a circle or an ellipse.

Conversely, partition walls 137 may be formed between the side dielectric ribs 127 and the front panel 120.

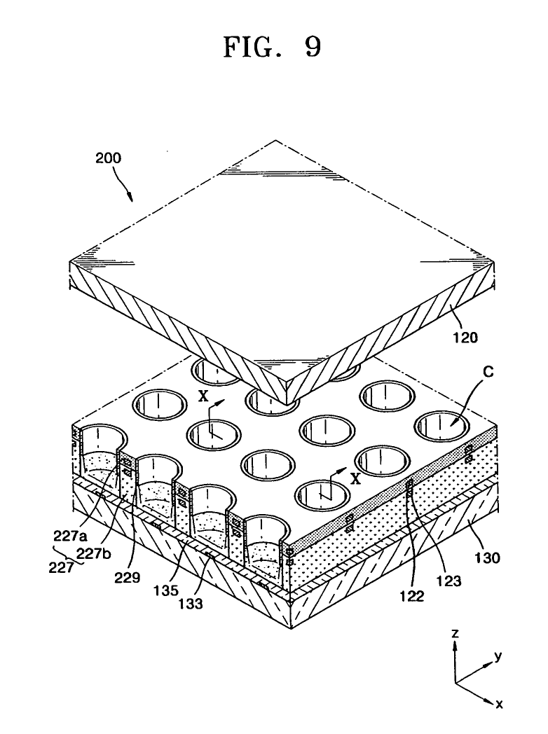

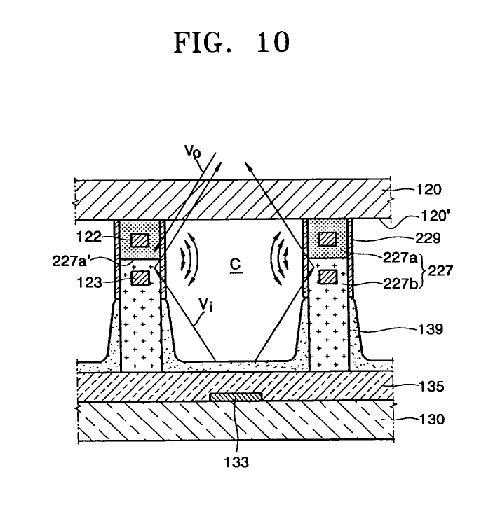

FIG. 9 is a perspective view of a PDP according to a second embodiment of the present invention, and FIG. 10 is a sectional view taken along line V-V of FIG. 9. Referring to FIGS. 9 and 10, a PDP 200 according to a second embodiment of the present invention includes a front panel 120, a rear panel 130, upper discharge electrodes 122, lower discharge electrodes 123, side dielectric ribs 227, phosphor layers 139, and a discharge gas. Also, the PDP 200 may further include protective layer 129, address electrodes 133, and a dielectric layer 135.

Since the front panel 120, the upper discharge electrodes 122, the lower discharge electrodes 123, the protective layer 129, the rear panel 130, the address electrodes 133, and the dielectric layer 135, and the phosphor layers 139 are identical to those of the first embodiment, the same reference numerals are used to them and their descriptions will be omitted.

The PDP 200 may further include partition walls 137. Since the structure and functions of the partition walls 137 have been described above with reference to FIG. 8, a detailed description thereof will not be repeated.

In this embodiment, each of the side dielectric ribs 227 has a first side dielectric rib 227a and a second side dielectric rib 227b.

The first side dielectric rib 227a is arranged between the front panel 120 and the rear panel 130 to partition the discharge cells C. The second side dielectric rib 227b is deposited on a lower portion 227a′ of the first side dielectric rib 227a. The first and second side dielectric ribs 227a and 227b are formed of dielectric materials.

In this case, the first side dielectric rib 227a takes on a dark color. Due to it, an external light V_{O} incident from an outside is absorbed by the first side dielectric rib 227a arranged closer to the outside than the second side dielectric rib 227b, thereby preventing the light from being reflected to the outside. Consequently, a nominal contrast ratio of the PDP increases.

In addition, the light transmittance of the second side dielectric rib 227b is higher than that of the first side dielectric rib 227a. Therefore, the visible rays Vi excited at the phosphor layer 139 are reflected without being absorbed by the second side dielectric rib 227b. A lot of the visible rays Vi excited at the phosphor layer are emitted to the outside through the front panel 120 such that the brightness of the PDP is improved. In this case, it is preferable that the second side dielectric rib 227b takes on a bright color because the bright color tends to reflect the light much more than the dark color.

That is, since the first upper barrier 227a arranged closer to the outside does not reflect the external light V_{O}, the nominal contrast ratio of the PDP is improved. Also, since the second side dielectric rib 227b arranged closer to the phosphor layer 139 reflects the visible rays Vi, the brightness of the PDP increases, resulting in improving the luminous efficiency.

Here, the bright color means a color having brightness of more than five or a metal color, such as aluminium, having a high light transmittance, and the dark color means color having brightness of less than four in a Munsell color system.

The first side dielectric rib 227a may include a dark-colored pigment in dielectric materials whose main component is PbO, B₂O₃ or SiO₂. That is, the side dielectric rib can easily take on the opaque dark color by adding the dark-colored pigment to the components of the front dielectric layer 25 adopted in the conventional PDP 10.

In this case, the pigment component may be one selected from the group including CdSe, CdS, CoO, Al₂O₃, ZnO, Fe₂O₃, Cr₂O₃, Cr₂O₃, MnO₂, CuO, and NiO.

Meanwhile, the nominal contrast ratio and the brightness can be optimally improved by adjusting a ratio of a height of the first side dielectric rib 227a to a high of the second side dielectric rib 227b. That is, the lower surface 227a′ of the first side dielectric rib 227a may be arranged on the upper surface of the upper discharge electrode 122, or between the upper discharge electrode 122 and the lower discharge electrode 123, or on the lower surface of the lower discharge electrode 123.

Specifically, if the upper discharge electrode 122 is arranged within the first side dielectric rib 227a and the lower discharge electrode 123 is arranged within the second side dielectric rib 227b, both the nominal contrast ratio and the brightness can be appropriately increased at the same time.

FIG. 11 is a modification of the PDP shown in FIG. 10. Referring to FIG. 11, the PDP further includes a floating electrode 225. The floating electrode 225 extends in parallel with the upper discharge electrode 122 and the lower discharge electrode 123 therebetween. The floating electrode 225 is not coupled to a separate active voltage source and it is formed of a material having a high electrical conductivity. However, the position of the floating electrode 225 is not limited to it. That is, the floating electrode 225 can be formed at any position enclosing the discharge cells C. Also, although FIG. 11 shows that one floating electrode 225 is arranged, a plurality of floating electrodes 125 can be arranged. Further, although FIG. 11 shows that the floating electrode 225 is formed on the second side dielectric rib 227b, the present invention is not limited to it. That is, the floating electrode 225 may be formed on the first side dielectric rib 227a or may be formed on both the first and second side dielectric ribs 227a and 227b.

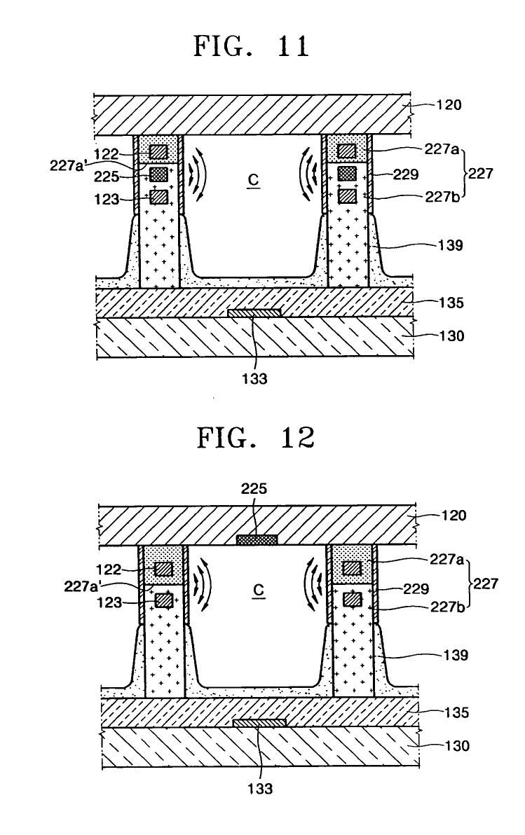

FIG. 12 is a second modification of FIG. 10. Referring to FIG. 12, a floating electrode 225 is disposed in one direction within a front panel 120. In a PDP 200 having the above construction, discharge is generated even in the front panel 120 as well as in sidewalls of first and second side dielectric ribs 227a and 227b where upper and lower discharge electrodes 122 and 123 are positioned. As a result, discharge area is extended increasing the discharge efficiency and reducing the discharge voltage. Herein, it is preferable that the floating electrode 225 be made of a transparent electrode material such as ITO since visible rays generated due to a discharge pass through the front panel 120.

As shown in FIG. 7A or 7B, the grooves 130a or 120a are formed in the rear panel 130 or the front panel 120, and the phosphor layers 139 may be coated at least on the grooves 130a or 120a. The embodiments of FIGS. 10, 11 and 12 can be modified to include the grooves 130a or 120a as shown in FIG. 7A or 7B. Since such configuration has been described above with reference to FIGS. 7A and 7B, a detailed description thereof will not be repeated.

As described above, according to the PDP of the present invention, since a front panel has no element thereon, aperture ratio can be remarkably increased and transmittance can be increased from 60% or less corresponding to a transmittance of the conventional PDP to about 90%.

Also, since side dielectric ribs prevent external light from being reflected, bright room contrast is increased and visible rays excited from the phosphor layer are reflected so that brightness and color purity are enhanced, resulting in an increase in light efficiency.

Further, since the structure of the PDP is improved remarkably and the amount of plasma is greatly increased, much visible rays are emitted, brightness is increased, and a low voltage operation is possible, thereby increasing the luminous efficiency.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A plasma display panel comprising:
a front panel;
a rear panel disposed in parallel with said front panel;
a plurality of opaque side dielectric ribs disposed between said front panel and said rear panel to define a plurality of discharge cells, and formed of a dielectric material;
a plurality of lower discharge electrodes and upper discharge electrodes disposed within said plurality of opaque side dielectric ribs;
a plurality of phosphor layers corresponding to the discharge cells; and
a discharge gas disposed inside the discharge cells.

2. The plasma display panel of claim 1, wherein said plurality of opaque side dielectric ribs take on a dark color.

3. The plasma display panel of claim 2, wherein said plurality of opaque side dielectric ribs include a dark-colored pigment.

4. The plasma display panel of claim 3, wherein said pigment includes at least one member selected from the group consisting of CdSe, CdS, CoO, Al₂O₃, ZnO, Fe₂O₃, Cr₂O₃, MnO₂, CuO, and NiO.

5. The plasma display panel of claim 1, further comprising at least one floating electrode disposed within said plurality of opaque side dielectric ribs accommodating enclosing the discharge cells.

6. The plasma display panel of claim 5, wherein said floating electrode extends in one direction parallel with and between said upper discharge electrode and said lower discharge electrode.

7. The plasma display panel of claim 1, further comprising at least one floating electrode extending in one direction within said front panel.

8. The plasma display panel of claim 1, further comprising a plurality of address electrodes extending to cross said upper discharge electrode and said lower discharge electrode, wherein said upper discharge electrode and said lower discharge electrode extend in one direction to be parallel with each other.

9. The plasma display panel according to claim 1, further comprising partition walls disposed between the side dielectric ribs and the rear panel, and defining the discharge cells in cooperation with the side dielectric ribs.

10. The plasma display panel of claim 1, further comprising a passivation layer covering sidewalls of each of said plurality of side dielectric ribs.

11. The plasma display panel of claim 1, wherein said plurality of phosphor layers corresponding to the discharge cells are provided on a plurality of grooves, respectively corresponding to the discharge cells, of one of said front panel and rear panel, the grooves providing greater surface area for the phosphor layers than the phosphor layers provided on the panel without grooves.

12. The plasma display panel of claim 1, wherein each one of said upper discharge electrodes being arranged to partly or completely enclose each one of the discharge cells.

13. The plasma display panel of claim 1, wherein said opaque side dielectric ribs, upper discharge electrodes, and lower discharge electrodes comprising a closed curve shape.

14. The plasma display panel of claim 1, wherein no electrodes are formed on one of the front and rear panels with the phosphor layers.

15. The plasma display panel of claim 1, further comprising partition walls disposed between said opaque side dielectric ribs and said front panel, and defining the discharge cells in cooperation with said opaque side dielectric ribs.

16. A plasma display panel comprising:
a front panel;
a rear panel disposed in parallel with said front panel;
a side dielectric rib including a plurality of first dark-colored side dielectric ribs disposed between said front panel and said rear panel to define a plurality of discharge cells and formed of a dielectric material, and a plurality of second side dielectric ribs stacked on lower surfaces of said plurality of first side dielectric ribs, formed of a dielectric material, and having a higher light reflectivity than said first side dielectric ribs;
a lower discharge electrode and an upper discharge electrode disposed within said plurality of side dielectric ribs;
a plurality of phosphor layers corresponding to the discharge; and
a discharge gas disposed inside the discharge cells.

17. The plasma display panel of claim 16, wherein said plurality of second side dielectric ribs take on a bright color.

18. The plasma display panel of claim 16, wherein said plurality of first side dielectric rib include a dark-colored pigment.

19. The plasma display panel of claim 18, wherein said pigment contains at least one member selected from the group consisting of CdSe, CdS, CoO, Al₂O₃, ZnO, Fe₂O₃, Cr₂O₃, MnO₂, CuO, and NiO.

20. The plasma display panel of claim 16, further comprising at least one floating electrode disposed within said plurality of side dielectric ribs accommodating enclosing the discharge cells.

21. The plasma display panel of claim 20, wherein said floating electrode extends in one direction parallel with and between said upper discharge electrode and said lower discharge electrode.

22. The plasma display panel of claim 16, further comprising at least one floating electrode extending in one direction within said front panel.

23. The plasma display panel of claim 16, further comprising a plurality of address
electrodes extending to cross said upper discharge electrode and said lower discharge electrode,
wherein said upper discharge electrode and said lower discharge electrode extend in one direction to be parallel with each other.

24. The plasma display panel of claim 23, wherein said plurality of address electrodes are disposed between said rear panel and said phosphor layer, and a dielectric layer is disposed between said address electrodes and said phosphor layer.

25. The plasma display panel of claim 16, further comprising a protective layer covering sidewalls of each of said plurality of side dielectric ribs.

26. The plasma display panel of claim 16, wherein said upper discharge electrode is disposed within said first side dielectric rib and said lower discharge electrode is disposed within said second side dielectric rib.

27. The plasma display panel of claim 22, wherein said floating electrode is transparent.

28. The plasma display panel of claim 16, wherein the dark color being a color having brightness of less than four in a Munsell color system.

29. The plasma display panel according to claim 16, further comprising partition walls disposed between the side dielectric ribs and the rear panel, and defining the discharge cells in cooperation with the side dielectric ribs.

30. The plasma display panel according to claim 16, wherein said plurality of phosphor layers corresponding to the discharge cells are provided on a plurality of grooves, respectively corresponding to the discharge cells, of one of said front panel and rear panel, the grooves providing greater surface area for the phosphor layers than the phosphor layers provided on the panel without grooves.

31. The plasma display panel according to claim 16, wherein said upper discharge electrode being arranged to partly or completely enclose at least one of the discharge cells.

32. The plasma display panel according to claim 16, wherein said side dielectric ribs, upper discharge electrodes, and lower discharge electrodes comprising a closed curve shape.

33. The plasma display panel according to claim 16, wherein no electrodes are formed on one of the front and rear panels with the phosphor layers.

34. The plasma display panel according to claim 16, further comprising partition walls disposed between the side dielectric ribs and said front panel, and defining the discharge cells in cooperation with the side dielectric ribs.
